(19) United States
(12) Patent Application Publication
(10) Pub. No.: US 2015/0363849 A1
(43) Pub. Date: Dec. 17, 2015

(54) DUAL CROWDSOURCING MODEL FOR ONLINE ARCHITECTURAL DESIGN

(71) Applicant: Arcbazar.com, Inc., Cambridge, MA (US)

(72) Inventor: Imdat AS, Boston, MA (US)

(73) Assignee: ARCBAZAR.COM, INC., Cambridge, MA (US)

(21) Appl. No.: 14/740,126

(22) Filed: Jun. 15, 2015

Related U.S. Application Data
(60) Provisional application No. 62/012,035, filed on Jun. 13, 2014.

(51) Int. Cl. G06Q 30/06

(52) U.S. Cl. CPC G06Q 30/0611

(57) ABSTRACT

Systems and methods for facilitating a design contest between clients and designers are provided. A client can provide a profile of a new design job. The design job can be published for bidding from designers. The bids can be received and ranked according to the preferences of the client. A prize can be awarded to winning designers. The client can receive the winning designs and use them to complete the new design job.

### RELATED APPLICATIONS

This application relates to and claims priority under 35 U.S.C. §119(e) to U.S. Provisional Patent Application No. 62/012,035, titled “DUAL CROWDSOURCING MODEL FOR ONLINE ARCHITECTURAL DESIGN PROJECTS, CONNECTING THE TRIUMVIRATE OF CLIENTS, ARCHITECTURAL DESIGNERS AND CONTRACTORS,” which was filed on Jun. 13, 2014 and is hereby incorporated by reference herein in its entirety.

### TECHNICAL FIELD

The field of the invention generally relates to computer-based methods and apparatuses, including computer program products, for architectural services, and specifically methods and systems for matching architectural designers and clients.

### BACKGROUND

Architectural designs are a critical component of any new construction or renovation project. Typically, a client will enlist the assistance of an architect or architectural firm to assist in the planning of a project prior to beginning construction. Architects may be selected based on word of mouth or other forms of advertising, but the process is slow and often results in a poor match between client needs and firm capabilities. In addition, architects/designers are typically very expensive and are limited to working in specific geographical areas, so there is no easy way for people to hire architects/designers from other countries. Accordingly, there is a need for a system that improves upon these challenges and provides more efficient matches of clients and architects.

### SUMMARY OF THE INVENTION

Embodiments of the disclosed subject matter can include a method for executing architectural projects through an online successive dual crowdsourcing model. The techniques can build on crowdsourcing the architectural project, first to architectural designers and subsequently to contractors. Thereby, the platform can network the key triumvirate of clients, architectural designers and contractors. The techniques can create a symbiotic relationship among these key players on an online platform. The system can symbiotically connect the key triumvirate of clients, designers and contractors to produce the architectural design through an online protocol described further herein. In the center of the process is the architectural project. The system can crowdsource multiple types of projects such as remodeling projects, interior design projects, landscape projects, new residential projects, commercial/public projects, or others.

According to some embodiments, a method for providing a design contest comprises receiving from a user device a profile corresponding to a job associated with a first design competition, publishing an indication of the design competition for bidding by designers, receiving bids from interested designers, ranking the received bids based on a plurality of preferences received from a user, awarding a prize to one or more winning designers, wherein the awarding the prize comprises automatically distributing prize money to the one or more winning designers, and sending an indication of the design contest results to the user device.

These and other capabilities of the disclosed subject matter will be more fully understood after a review of the following figures, detailed description, and claims. It is to be understood that the phraseology and terminology employed herein are for the purpose of description and should not be regarded as limiting.

### BRIEF DESCRIPTION OF FIGURES

Various objectives, features, and advantages of the disclosed subject matter can be more fully appreciated with reference to the following detailed description of the disclosed subject matter when considered in connection with the following drawings, in which like reference numerals identify like elements.

FIG. 1 is an exemplary system for providing an architectural design contest in accordance with some embodiments.

FIG. 2 is an exemplary expanded server view for a system for providing an architectural design contest in accordance with some embodiments.

FIG. 3 is an exemplary computerized flow diagram illustrating the initiation of a design contest in accordance with some embodiments.

FIG. 4 is an exemplary computerized flow diagram illustrating the process of bidding and ranking submitted designs in accordance with some embodiments.

FIG. 5 is an exemplary computerized flow diagram illustrating selection of sponsors in accordance with some embodiments.

FIG. 6 is an exemplary computerized flow diagram illustrating project cost estimation in accordance with some embodiments.

FIG. 7 is an exemplary screenshot of the user interface showing a Top Designer

Ranking page in accordance with some embodiments.

FIG. 8 is an exemplary screenshot of the rating/ranking module used to rank designs and designers in accordance with some embodiments.

FIG. 9 is an exemplary screenshot of the designer exchange platform allowing the exchange of designs between participants in accordance with some embodiments.

FIG. 10 is an exemplary screenshot of various schema that can be used to estimate an award in accordance with some embodiments.

FIG. 11 is an exemplary screenshot of the award estimator user interface page for use with the award estimator in accordance with some embodiments.

FIG. 12 is an exemplary screenshot of the upload page for a new design project in accordance with some embodiments.

FIG. 13 is an exemplary screenshot of the sponsor tagging feature of an image in accordance with some embodiments.

### DETAILED DESCRIPTION

In the following description, numerous specific details are set forth regarding the systems and methods of the disclosed subject matter and the environment in which such systems and methods may operate, in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the embodiments described below are only examples, and that it is contemplated that there are other systems and methods that are within the scope of the disclosed subject matter.

The system allows clients to crowdsource their design projects and launch global design contests. In the first phase of this process, the client can launch a design contest, e.g. an addition to a home, remodeling of retail space, design of an entire family home, a landscape project, a mixed-use development, or any other architectural design project. The client can describe the project (e.g., what the client wants, design goals, functionality), upload images, and provide basic specifications that forms the basis for architectural designers to develop their concepts and compete in the contest. The client can set the award for the project, timeline, and can select eventually the winning design entrie(s) (e.g., three entries). The client can pay the award upfront, and the system can distribute the awards to a top designer, or a plurality of designers. For example, the system can distribute the award to the top three designers according to the following rule: The 1^{st} ranked designer gets 60% of the award, the 2^{nd} ranked designer gets 30% of the award and the 3^{rd} ranked designer gets 10% of the award. The process can be anonymous and the system can generate contest-specific alias numbers for designers. This modus operandi keeps the ranking of projects strictly merit-based. In the second phase of this process, local contractors can bid for the implementation of the winning design entry. The client can connect to the most fitting local contractor, who can then implement the project in the real world.

The system can consist of public and private pages. The public areas are open to any user and include the Project/Contest Pages, Charts, and the Webpage Scaffold. The Project/Contest pages constitute the system's project browser, which allow users to review and vote on completed projects to rank projects and contests. The Charts contain top designers in the form of Top 50 lists that can be filtered based on continent and project category. Designers are ranked according to the points they collect. The Webpage Scaffold is the information framework of the system and contains the “How it Works,” FAQ, Worldmap, Estimator, and related pages, described in further detail herein. Private pages require the user to register and login to access the content. They consist of the running Contests, Client-, Designer- and Contractor user interfaces.

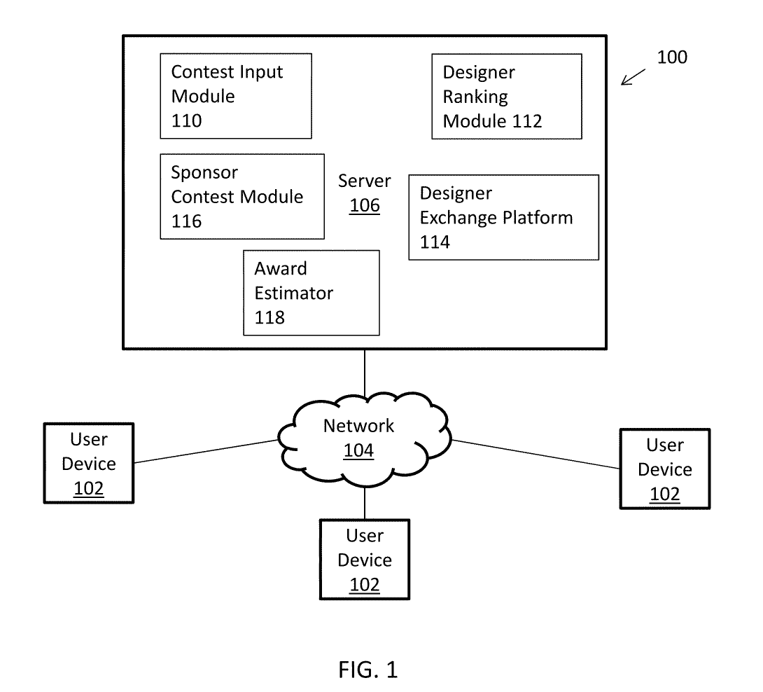

FIG. 1 is a system diagram showing the networked system 100, according to some embodiments. System 100 includes user devices 102, a network 104, and a server 106. The server 106 is further comprised of contest input module 110, designer ranking module 112, designer exchange platform 114, sponsor contest module 116, and award estimator 118.

User device 102 is in communication with network 104. The user device 102 can be any device capable of communicating with network 104. For example, the user device 102 can be a laptop, personal computer, cell phone, including a personal digital assistant (PDA), a smartphone, or other device permitting communication between a user and network 104.

Each user device 102 can send data to, and receive data from, the server 106 over the communication network 104. Each user device 102 can be directly coupled to the server 106; alternatively, each user device 102 can be connected to server 106 via any other suitable device, communication network, or combination thereof. For example, each user device 102 can be coupled to the server 106 via one or more routers, switches, access points, and/or communication networks (as described below in connection with communication network 104). Each user device 102 can also include a memory. The memory can be a non-transitory computer readable medium, flash memory, a magnetic disk drive, an optical drive, a programmable read-only memory (PROM), a read-only memory (ROM), or any other memory or combination of memories. The software can run on a processor capable of executing computer instructions or computer code. The processor might also be implemented in hardware using an application specific integrated circuit (ASIC), programmable logic array (PLA), field programmable gate array (FPGA), or any other integrated circuit.

A user device 102 can include any computing device that is capable of performing computation and is also capable of providing location information. The location information can include a Global Positioning System (GPS) coordinate or a latitude/longitude coordinate. The user device 102 can include a desktop computer, a mobile computer, or a tablet computer. The user device 102 can also include a cellular device, including user equipment. The user equipment communicates with one or more radio access networks and/or with wired communication networks. The user equipment can be a cellular phone having phonetic communication capabilities. The user equipment can also be a smart phone providing services such as word processing, web browsing, gaming, e-book capabilities, an operating system, and a full keyboard. The user equipment can also be a tablet computer providing network access and most of the services provided by a smart phone. The user equipment operates using an operating system such as Symbian OS, iPhone OS, RIM's Blackberry, Windows Mobile, Linux, HP WebOS, and Android. The screen might be a touch screen that is used to input data to the mobile device, in which case the screen can be used instead of the full keyboard. The user equipment can also keep global positioning coordinates, profile information, or other location information.

The user device 102 also includes any platforms capable of computations and communication. Non-limiting examples can include televisions (TVs), video projectors, set-top boxes or set-top units, digital video recorders (DVR), computers, netbooks, laptops, and any other audio/visual equipment with computation capabilities. The user device 102 is configured with one or more processors that process instructions and run software that can be stored in memory. The processor also communicates with the memory and interfaces to communicate with other devices. The processor can be any applicable processor such as a system-on-a-chip that combines a CPU, an application processor, and flash memory. The user device 102 can also provide a variety of user interfaces such as a keyboard, a touch screen, a trackball, a touch pad, and/or a mouse. The user device 102 can also include speakers and a display device in some embodiments.

The network 104 can be a local area network (LAN), a wide area network (WAN), the Internet, a cellular network, a satellite network, or another network that permits communication between user devices 102 and server 106. The network 104 can further include one, or any number, of the exemplary types of networks mentioned above operating as a stand-alone network or in cooperation with each other. The network 104 can utilize one or more protocols of one or more clients or servers to which they are communicatively coupled. The network 104 can translate to or from other protocols to one or more protocols of network devices. Although the network 104 is depicted as one network, it should be appreciated that in some embodiments, the network 104 can comprise a plurality of interconnected networks. Other various network types or configurations can also be provided.

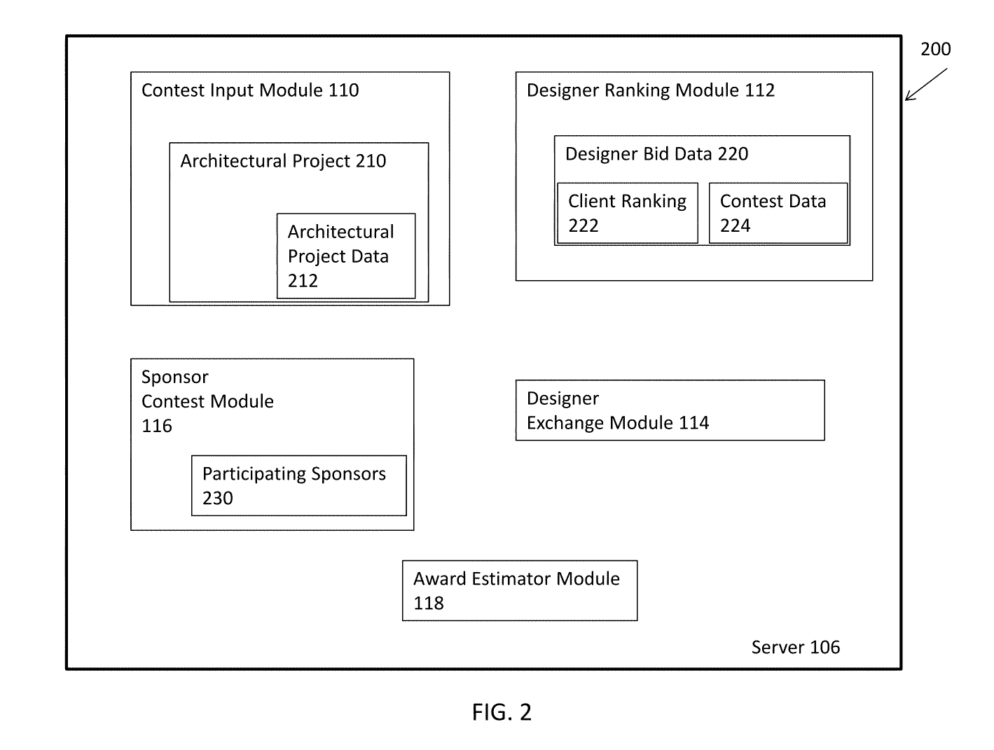

The server 106 can contain modules that implement the architectural matching system as described more fully in FIG. 2 below. The server 106 contains a plurality of modules, including Contest Input Module 110, Designer Ranking Module 112, Designer Exchange Platform 114, Sponsor Contest Module 116, and Award Estimator 118. Each of these modules and their subcomponents are described more fully in FIG. 2.

The server 106 can operate using an operating system (OS) software. In some embodiments, the OS software is based on a Linux software kernel and runs specific applications in the server such as monitoring tasks and providing protocol stacks. The OS software can allow server resources to be allocated separately for control and data paths. For example, certain packet accelerator cards and packet services cards can be dedicated to performing routing or security control functions, while other packet accelerator cards/packet services cards can be dedicated to processing user session traffic. As network requirements change, hardware resources can be dynamically deployed to meet the requirements in some embodiments.

The server's software can be divided into a series of tasks that perform specific functions. These tasks communicate with each other as needed to share control and data information throughout the server 106. A task can be a software process that performs a specific function related to system control or session processing. Three types of tasks operate within the server 106 in some embodiments: critical tasks, controller tasks, and manager tasks. The critical tasks control functions that relate to the server's ability to process calls such as server initialization, error detection, and recovery tasks. The controller tasks can mask the distributed nature of the software from the user and perform tasks such as monitoring the state of subordinate manager(s), providing for intra-manager communication within the same subsystem, and enabling inter-subsystem communication by communicating with controller(s) belonging to other subsystems. The manager tasks can control system resources and maintain logical mappings between system resources.

Individual tasks that run on processors in the application cards can be divided into subsystems. A subsystem is a software element that either performs a specific task or is a culmination of multiple other tasks. A single subsystem can include critical tasks, controller tasks, and manager tasks. Some of the subsystems that run on the server 106 include a system initiation task subsystem, a high availability task subsystem, a shared configuration task subsystem, and a resource management subsystem.

The system initiation task subsystem can be responsible for starting a set of initial tasks at system startup and providing individual tasks as needed. The high availability task subsystem works in conjunction with the recovery control task subsystem to maintain the operational state of the server 106 by monitoring the various software and hardware components of the server 106. The recovery control task subsystem can be responsible for executing a recovery action for failures that occur in the server 106 and receives recovery actions from the high availability task subsystem. Processing tasks can be distributed into multiple instances running in parallel so that if an unrecoverable software fault occurs, the entire processing capabilities for that task are not lost. User session processes can be sub-grouped into collections of sessions so that if a problem is encountered in one sub-group users in another sub-group will not be affected by that problem.

The shared configuration task subsystem can provide the server 106 with an ability to set, retrieve, and receive notification of server configuration parameter changes and is responsible for storing configuration data for the applications running within the server 106. The resource management subsystem can be responsible for assigning resources (e.g., processor and memory capabilities) to tasks and for monitoring the task's use of the resources.

FIG. 2 is an expanded view of the various modules 110-118 and their subcomponents implemented within server 106 from FIG. 1. In FIG. 2, server 106 contains Contest Input Module 110, Designer Ranking Module 112, Designer Exchange Platform 114, Sponsor Contest Module 116, and Award Estimator 118.

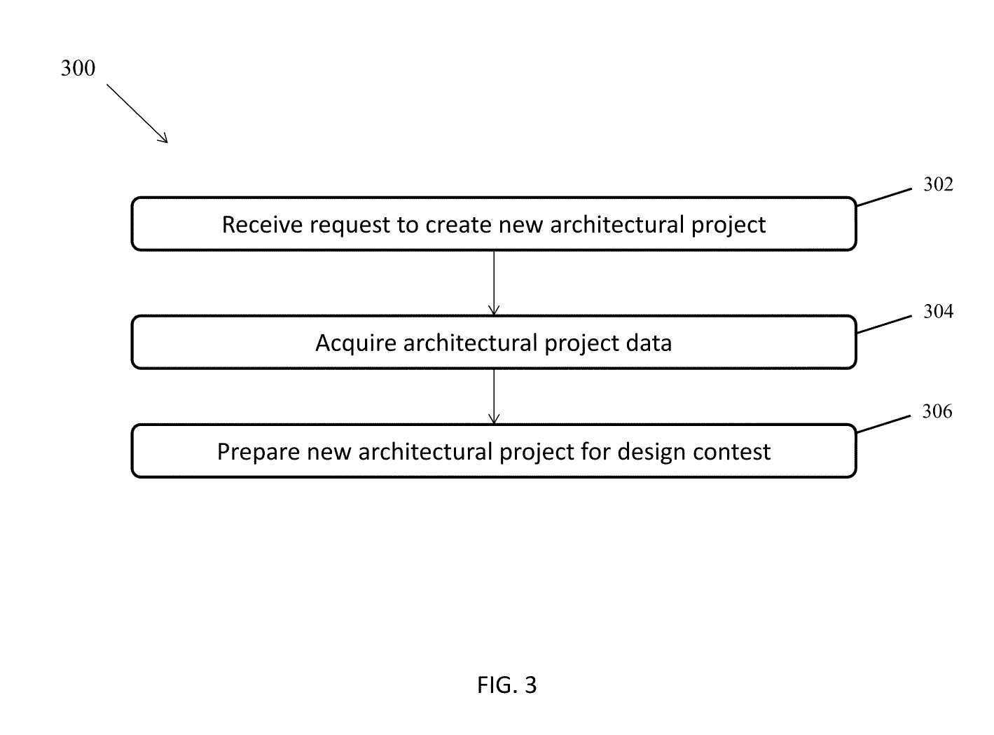

Contest Input Module 110 is a module within server 106 configured to acquire data from a user via user device 102 and generate a new architectural project. Contest Input Module 110 can store architectural project 210. Architectural project 210 is a design project submitted by a user associated with user device 102. Architectural project 210 will contain information regarding a particular architectural design job that can be provided to designers for bidding at a different module. Architectural project 210 can further be associated with architectural project data 212. Architectural project data can be acquired from numerous sources, including directly from user devices 102. Contest Input Module 110 can be configured to execute the computerized method described in FIG. 3.

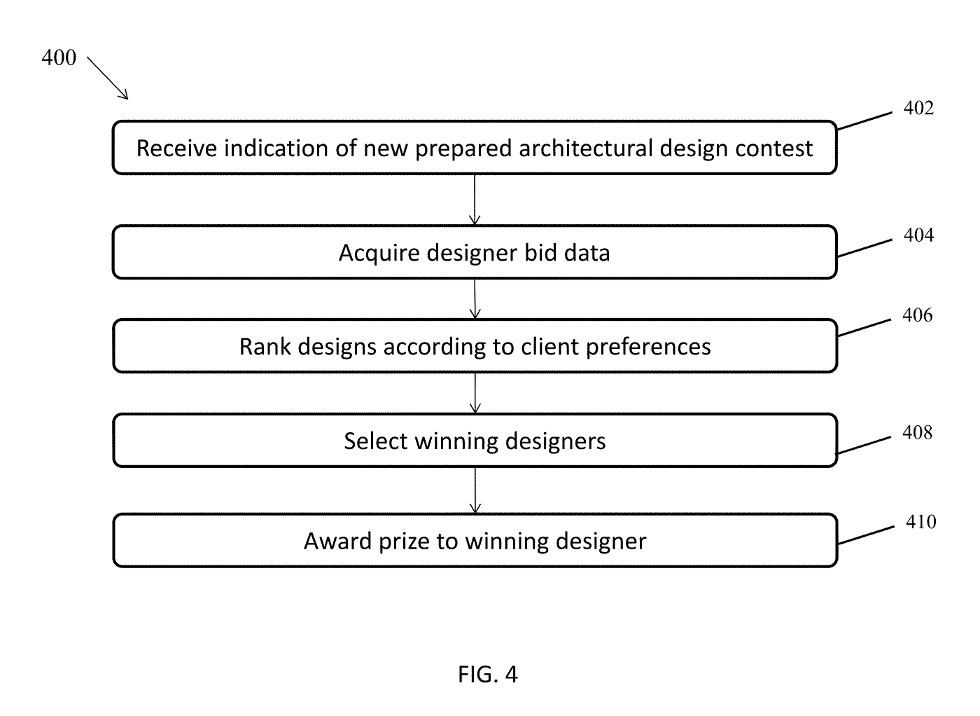

Designer Ranking Module 112 is a module within server 106 configured to acquire rank bids from designers for an architectural project, such as architectural project 210. Designer Ranking Module can be configured to institute a design contest in accordance with some embodiments, as described more fully in FIG. 4 below. Designer Ranking Module 112 can store designer bid data 220. Designer Ranking Module 112 can publish a new architectural project for bids from designers. Submitted bids can be stored as designer bid data 220. Designer Ranking Module 112 can use the acquired designer bid data 220 to rank the bids of the designers. Designer Ranking Module 112 can be configured to execute the computerized method described in FIG. 4.

Designer Exchange Platform 114 is a module within server 106 configured to facilitate exchange of completed or in-progress designs between designers bidding on architectural project 210. Designers may opt in to the service provided by Designer Exchange Platform 114, and may share a contest award associated with the winning design if the collaboration is chosen as a winner.

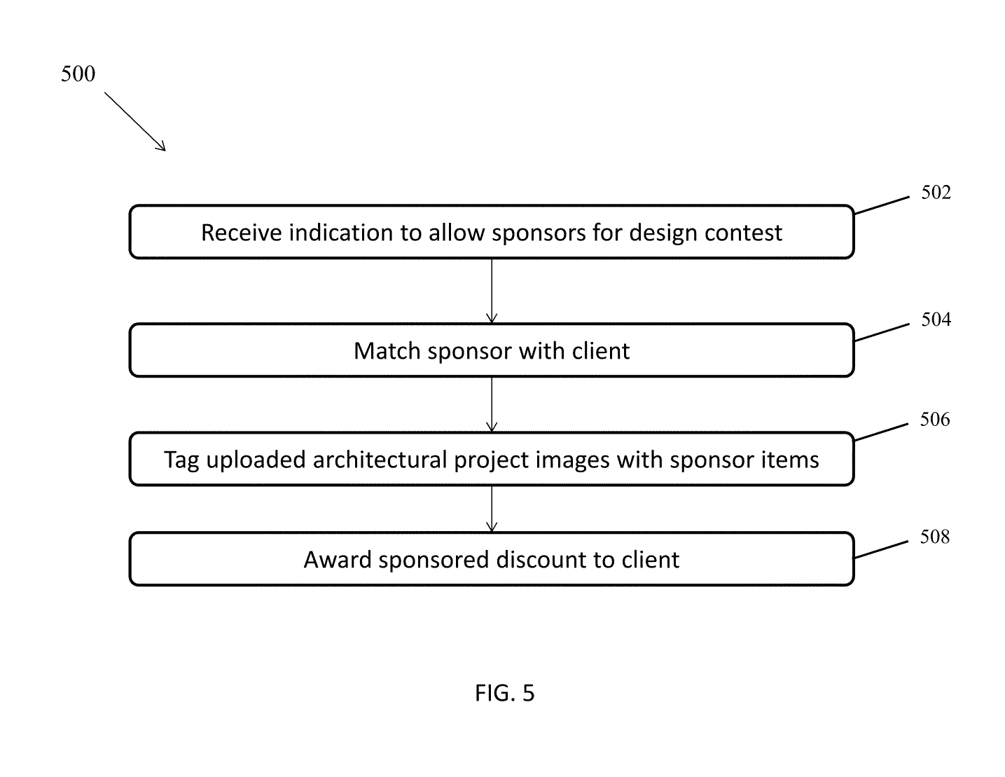

Sponsor Contest Module 116 is a module within server 106 configured to solicit sponsorship of a project such as architecture project 210. Sponsor contest module can obtain architectural project data 212 from Contest Input Module 110. In one embodiment, the obtained architectural project data can include an image of a space to be designed in a design contest. Sponsor Contest Module 116 can publish a listing associated with architectural project 210. A list of sponsors expressing interest in a particular architectural project can be stored in a list of participating sponsors 230. Sponsor Contest Module 116 can be configured to execute the computerized method described in FIG. 5.

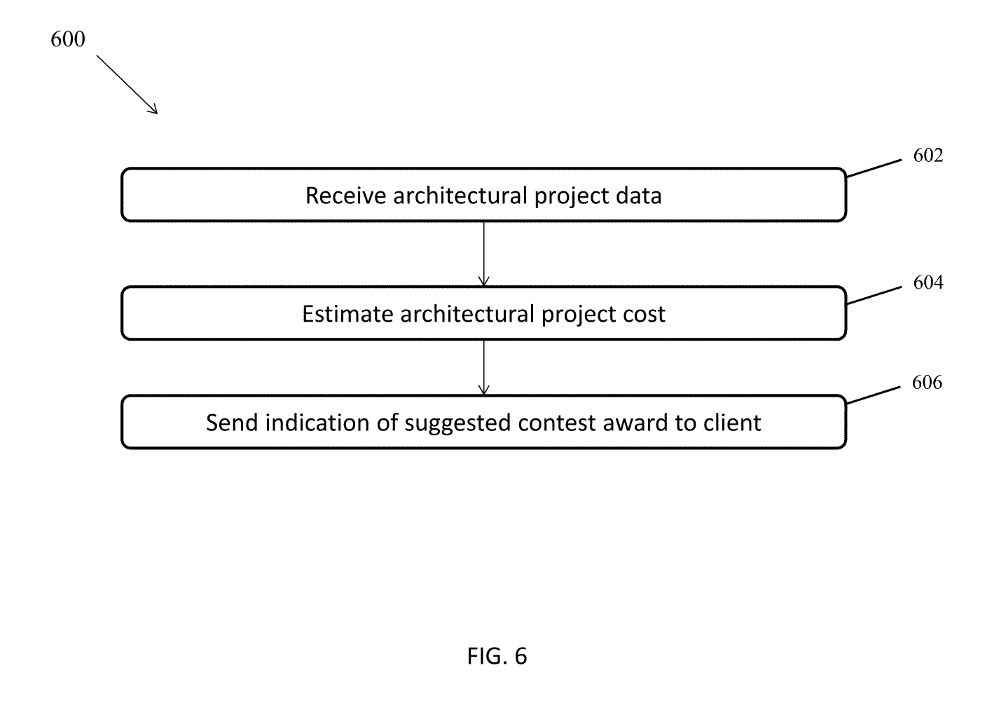

Award Estimator 118 is a module within server 106 configured to estimate a cost associated with an architectural project, such as architectural project 210. Award estimator 118 can estimate a cost based on a number of factors before the project is submitted for bidding by designers. Award Estimator 118 can therefore assist a user in determining an Award Estimator 118 Ranking Module 112 can be configured to execute the computerized method described in FIG. 6.

FIG. 3 is a computerized method 300 to demonstrating a process for generating a design contest for a client. Method 300 contains stages 302, 304, and 306. At stage 302, a new architectural project 210 is initiated by a user associated with user device 102. At stage 304, architectural project data 212 associated with new architectural project 210 is acquired. At stage 306, the new architectural project is compiled and prepared by the system.

At stage 302, a new architectural project 210 can be initiated. A user associated with one user device 102 can connect to the server 106 to prepare a new architectural design project, e.g., architectural project 210. The user may connect to the system via a desktop or mobile user interface. User device 102 can be any mobile or desktop device capable of interfacing with system 100.

At stage 304, architectural project data 212 can be acquired. When initiating a new architectural design project, a user can input a number of characteristics into the system, such as those important to describe the project to designers and architects. For example, the user can input the dimensions of a space associated with the project, a target cost, preferred designers or contractors, preferred sponsors, an image of the space to be designed, or any other characteristic that would assist a designer in preparing a bid. These characteristics can be collected and stored by Contest Input Module 110.

At stage 306, the new architectural project 210 can be prepared for use in a design contest. At this stage, architectural project data can be compiled and processed by Contest Input Module 110 for use in a new architectural contest. Once compiled, the new architectural project can be communicated to other modules, e.g., Designer Ranking Module 112, for further processing.

FIG. 4 provides a computerized method 400 to rank prospective architectural designers. Method 400 contains stages 402, 404, 406, 408, and 410. At stage 402, new architectural project 210 is received by Designer Ranking Module 112. At stage 404, designer bid data is acquired. At stage 406, participating designers are ranked. At stage 408, one or more designers are selected as winners of the contest. At stage 410, the prize money can be awarded and distributed to the one or more winning designers.

At stage 402, server 106 makes a new architectural project available to designers for bidding. At this stage, a design contest is started. The new architectural design project can be any design project submitted by a user. In one embodiment, the new architectural design project can be new architectural design project 210 submitted associated with Contest Input Module 110.

At stage 404, designer bid data 220 is acquired. Designer bid data 220 can be data associated with a designer's bid for an architectural project associated with the design contest. At this stage, designers may review the architectural project 210 and choose to participate in the contest by creating and submitting designs for review by the user. In one embodiment, a plurality of designers can share files amongst each other during a particular contest. Designers can share most items associated with a bid, such as CAD drawings, PDF documents, images, or research documents. These items can be shared for points to improve the designer's ranking, for a set money amount, or for a cut of the potential award a designer may win. The exchange platform can foster the designer community and allows designers to form ad-hoc teams across geographies by sharing work.

Designer bid data may be compiled at any time after a contest is opened for bidding, but bid data generally is not complete until a designer has submitted a proposal that has been reviewed by the client. Designer bid data 220 can include client ranking 222 and contest data 224. Client ranking 222 can be a ranking assigned to a designer's proposal based on feedback from the client associated with architectural project 210. Client ranking 222 is used in conjunction with contest data 224 to determine winners of a contest.

Client ranking 222 can be generated by clients choosing to rate submitted designs themselves, or can be generated via external ratings. The external ratings can comprise ratings of family member or friends, ratings of other designers, and/or the like. To rate designers, clients can browse through all material submitted by a designer associated with architectural project 210. For example, the client can browse image files, PDF documents, video/audio links, as well as descriptions provided by participating designers. The user interface accessed through one of user devices 102 can include a “Rate this Submission” feature which allows the client to fill out a short evaluation form with a comment field. In one embodiment, the page can include a five question survey. In one exemplary implementation, the questions can be rated from a seven point scale that ranges from “not at all” to “somewhat” to “very well.” Some exemplary survey statements can include : “Design is aesthetic—it's beautiful”; “Design is practical—it functions well!”; “Design is buildable—I think it's buildable”; “Project met the selection criteria”; and “The graphic material was great!” The ratings generated by clients can affect the star rating of designers.

External ratings are collected through “Family & Friends” ratings and designer votings. Family & Friends ratings can enable clients to share all or a subset of submissions with their family and friends. Anyone to whom the client sends his/her submissions can rate and rank them. All information can be shown in a cumulative ranking of designs rated by family and friends. This list can include a counter showing how many people have responded. Designs with most points can be ranked on top of this list. Each list item can show the rank order, the alias number of the designer, the total points collected by family friends, and the cumulative points collected for each sub-category (e.g., the categories of beauty, functionality, buildability, client criteria, and visual graphics).

Contest data 224 can be data associated with a designer that is calculated based on various actions a designer can perform throughout the contest. These actions can include, for example, signing up for a competition or submitting designs for a competition. The point system can be calculated based on a duration, complexity, and award of the particular competition a designer participates in. Additional points can be given by the client ranking 222 when awarding 1^{st}, 2^{nd}, or 3^{rd} prizes for designers. For example, in one implementation, points could be assigned to a designer for signing-up for a project; submitting a project; signing up for, but not submitting a project; receiving an honorable mention; or winning 1^{st}, 2^{nd}, or 3^{rd} prize. In addition, the system can reward designers' participation in low-award contests, by adding additional points when awards are lower. For example, more points can be awarded for participating in a contest between $250-$499, than for participating in a contest between $1,000-$1,499. A higher point value associated with contest data 224 can provide a designer a higher ranking in the designer charts, which increases the possibility of the designer getting invited to a competition by the client, and the visibility of the designer and his/her projects on the site.

At stage 406, designers can be ranked according to client ranking data 222 and contest data 224. In this stage, all data can be shown in an overall ratings page. This page can list the final ranking of designs ordered according to the client ratings. Each list item can contain information including, for example: rank order; thumbnail of cover image; the alias number of a designer; the points collected by a designer; the award amount (e.g., the total award distributed among the top 3 ranked designers such that the 1^{st} ranked project receives 60% of the award, 2^{nd} ranked project receives 30% of award, and 3^{rd} ranked project receives 10% of the award); a checkbox where client can decide whether designers receive honorable mentions; family & friends column showing the first three choices of the ratings by family and friends; and designer voting results. Clients can drag and drop each list item up and down to change the ranking order. The list can always be reset to the initial client ratings order.

At stage 408, winning designers can be selected. At this stage, once the client is satisfied with the final ranking order they can submit them to the system. This action causes automatic e-mail notifications about the results to be sent to all designers who participated in the contest. In addition, the contest is automatically enlisted on the top contests, and top projects pages. Then the system 100 issues points and awards to participating designers based on their performance. Designers can access client comments about their particular designs.

At stage 410, the winning designers can be awarded prize money associated with the contest. For example, the top 3 award winning designers can receive monetary awards. The award amount gets posted on their account information. The client can additionally choose to connect with the winning designer. If the client decides to do so, an automatic introduction email with contact details can be sent out to both the winning designer and the client. Finally, the client can optionally open their winning design to a bidding procedure to local contractors in order to implement their project. If clients choose to follow-up on this second phase of the project the system directs them to the project bidding page. This stage concludes the design contest.

Previous rankings of designers by other clients can be used to form lists of top designers that a user can review and analyze when selecting designers in stage 404. For example, lists of the top 50 participants, top 50 performers, top projects, and top contests can be compiled. These lists can be supported by a user voting system, which also can produce a list of the top reviewers in the system. These lists can be filtered based on location and category of project, i.e. remodeling, interior design, and landscape, new residential and commercial/public. These lists can be used by clients after submitting new architectural project 210 to invite top designers to participate in bidding on the new architectural project 210.

In some embodiments, a rank of a designer can be generated using an amount of points (P) a designer has collected. The more points a designer collects the higher the designer can be ranked. In one embodiment, a rank within the top 50 participants list can be determined as the amount of points collected divided by number of contests participated (K). K=(P)×{[(number of 1st Prize)×3]+[(number of 2nd Prize)×2]+(number of 3rd Prize)}/(number of Total Projects Participated). For example, a designer could participate in 250 projects, wins 26 1st Prizes, 38 2nd Prizes, and 42 3rd Prizes. In this case, the designer would collect 77,045 points (P). The performance point is as follows: K=(77,045)×[(26×3)+(38×2)+(42)]/250=60,403. The Top Reviewers charts 307 (J) is calculate based on (K) in the following way: J=K+[(number of votings)×100]+[(number of reviews)×100]+[(number of loves)×10]. As another example, a user's K value can be 60,403 points, and the user voted on 10 projects: then, J=60,403+(10×100)=61,403. Note, if the user did not vote on any project, number of votings is 0, and therefore J=0. This means that a new user, for example, with only one vote has 100 points and will surpass this user in the Top Reviewers list.

In some embodiments, the top project list can generated. The top project list is a listing of top designs submitted to the site across all contests. A project's ranking in the list can be calculated as follows. First, the number of total project submissions by different designers to a particular contest is determined. Second, the number of award points of assigned to a project is calculated. Third, a value associated with whether the project has won an award for contest is determined. Fourth, a value for the total number of votes received in favor of the project is determined and multiplied by five. Finally, the average vote score for the project is determined, where vote scores are out of 100. These five factors are added together to give a total number of points for a project.

Award points may be assigned on a sliding scale; for example, 2 points can be awarded for a project worth less than $250, 3 points for a project in the range of $251-$500, 5 points for a project in the range of $501-$750, 8 points for a project in the range of $751-$1000, 13 points for a project in the range of $1001-$2500, 24 points for a project in the range of $2501-$5000, and 34 points for a project worth more than $5001. In addition, 180 points can be awarded for receiving 1^{st} Prize, 90 points can be awarded for receiving 2^{nd} Prize, 30 points can be awarded for receiving 3^{rd} Prize, 20 points can be awarded for receiving an Honorable Mention, 0 points can be awarded for receiving no award, and 200 point can be deducted for having a submission flagged by a client. In one example, for a project associated with a particular design contest, the total award for the contest can be $7,500, with 27 designs submitted. The design project in question may have received no votes, and been awarded 1^{st} prize. In this case, the total number of points assigned to the project for ranking purposes would be 27+34+180+0+50=291.

In some embodiments, the top contest list can generated. The top contest list is a listing of the top contests submitted on the site across all clients. A contest's ranking in the list can be calculated as follows. First, the number of submissions by different designers is determined and multiplied by two. Second, the number of award points of a project is calculated. Third, the number of projects submitted to the contest that have received votes is calculated. Finally, the average of the vote totals for each of the top three projects is calculated where vote scores are out of 100. These four factors are added together to give a total number of points for a contest.

Award points may be assigned on a sliding scale; for example, 2 points can be awarded for a project worth less than $250, 3 points for a project in the range of $251-$500, 5 points for a project in the range of $501-$750, 8 points for a project in the range of $751-$1000, 13 points for a project in the range of $1001-$2500, 24 points for a project in the range of $2501-$5000, and 34 points for a project worth more than $5001. If a project is not voted on, it is assigned a value of 50. Continuing the above example, for a particular design contest, the total award for the contest can be $7,500, with 27 designs submitted. The contest in question may have not received any votes. In this case, the total number of points for the contest would be 54+34+0+50=138.

FIG. 5 is an exemplary computerized flow diagram illustrating selection of sponsors, according to some embodiments. Method 500 contains stages 502, 504, 506, and 508. At stage 502, the sponsor contest module can receive an indication to allow sponsors for a design contest. Sponsorship is an optional feature that can allow clients to select partnering third-party companies to sponsor part or the entirety of their contest award. Third-party companies are product or service providers relevant to the design contest; these can include, for example, home improvement companies, such as Home-Depot or Lowe's; furniture companies, such as IKEA, Restoration Hardware, etc., and any other relevant companies, such as plumbers, painters, or others.

At stage 504, sponsors can be matched with clients. During the matching process, the client can see all participating third-party companies (e.g., participating sponsors 230) in the sponsors feature, and can review their offerings. As indicated, the sponsor feature is optional and non-binding. Thus the client may choose no sponsor, or choose sponsor(s) and not purchase from them eventually. Once clients choose sponsors for their contests, designers will be able to see the sponsors and their products and services on the contest's page, and will be encouraged, at will, to use the products and services of these sponsors in their design solutions. Clients may get a discount on their award money by choosing a sponsor. For example, sponsor A may give a $50 discount to the overall contest award calculation. In addition, throughout the contest family/friends can contribute to the contest and thus decrease the cost of the client. Designers do not have to use products and services of sponsors, but if they do, they can earn additional money by getting a cut of the goods sold based on their designs. When designers upload their designs to the system, the list of items from sponsors will be tagged in the images viewer, and their products and services enlisted. Here designers can tag all products and services used in their design solutions. This will generate a list of items and services to be purchased, and show their itemized and total costs to the client. When the client decides to purchase all or part of these items through the system, the client receives corresponding offerings from the sponsors, and the designers receive a cut (e.g. 2% of goods sold). In addition, the amount earned through this process will be added to their “bank account,” associated with the website, and the hosting company can receive a cut, (e.g., 2% of goods sold) from third-party companies.

The sponsor feature may allow clients to get part or all of the contest award back, and designers can earn additional money if they win the contest and the client purchased the sponsor items through the system. In some embodiments, this is perpetual, such that if any user purchases items from the particular image in future, the designer can continue receiving the cut on goods sold.

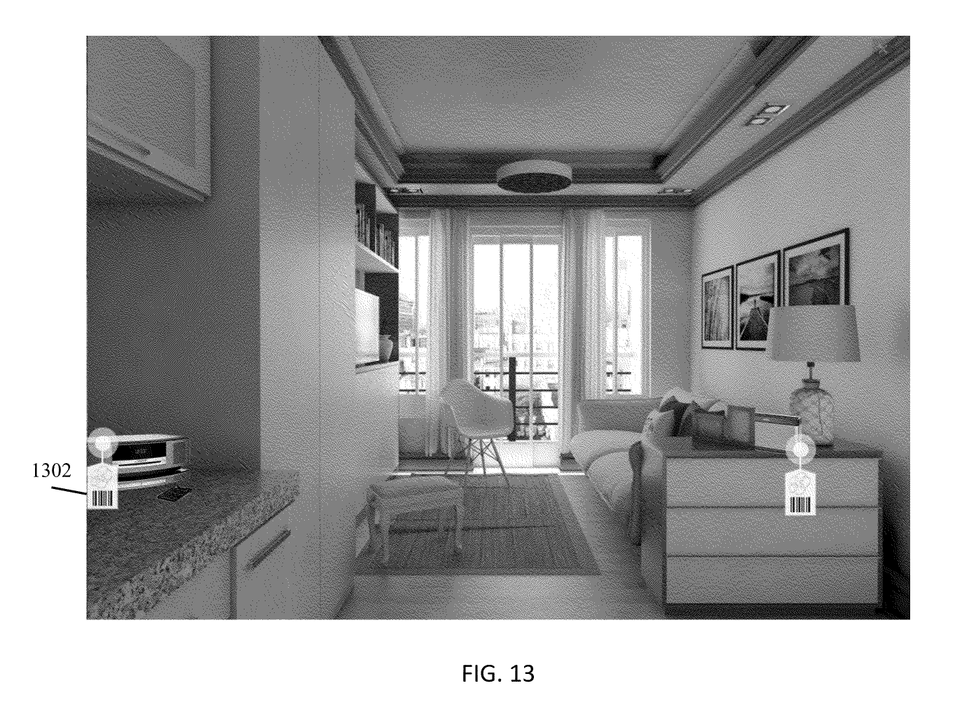

At stage 506, matched sponsors can be tagged to architectural project images uploaded by a user. These tags can be displayed on the contest page and overlaid on top of an image of the space associated with the architectural project 210. This feature is illustrated in FIG. 13 below.

At stage 508, a discount can be awarded to the client based on the agreed sponsorship. These discounts can be one of the following options: offer a percentage of final purchase amount, (e.g., 5% of goods purchased from third-party company); offer a percentage of final purchase amount up to a limit, (e.g., 5% of goods purchased from third-party company up to $200); offer direct credit, (e.g., 50$ coupon for goods to be purchased by third-party company); or other offers.

FIG. 6 is a computerized method 600 for estimating an architectural project cost associated with architectural project 210. Method 600 contains stages 602, 604, and 606. At stage 602, architectural project data 212 associated with architectural project 210 is received at award estimator 118.

At stage 604, a cost associated with generating a design for the architectural project 210 is estimated. The cost estimation algorithm can take into account a number of factors, such as the main five categories of projects, (e.g., remodeling, interior, landscape, new residential and commercial/public); the type of contests, (e.g., Kitchen, Bathroom, Additions, Office space, etc.); the scale of contests, (e.g. single, multiple rooms, 400 sqf, etc.); the duration of contests, (e.g. 3 days, 2 weeks, etc.); and the budget of the project—covering implementation, materials, etc., (e.g., $60k, $120k etc.) The final award can be the total of all of these factors. However, this can be a suggested award and clients are free to offer any amount equal or above the category minimums. Once clients provide the abovementioned information the system can generate an estimation page with the suggested award. It also shows what the client would have traditionally paid and what the savings are by launching a contest on the website.

At stage 606, the estimated award is sent to the client. This information can be used by the client during generation of the architectural project 210 by Contest Input Module 110 to set a base bidding price for designers to use. Clients can save the information they provided through a save button on this page. Once the client completes the registration, the information provided in the estimator module is transferred and enlisted at the client's My Projects page. It allows clients to easily complete the process and launch their design contests.

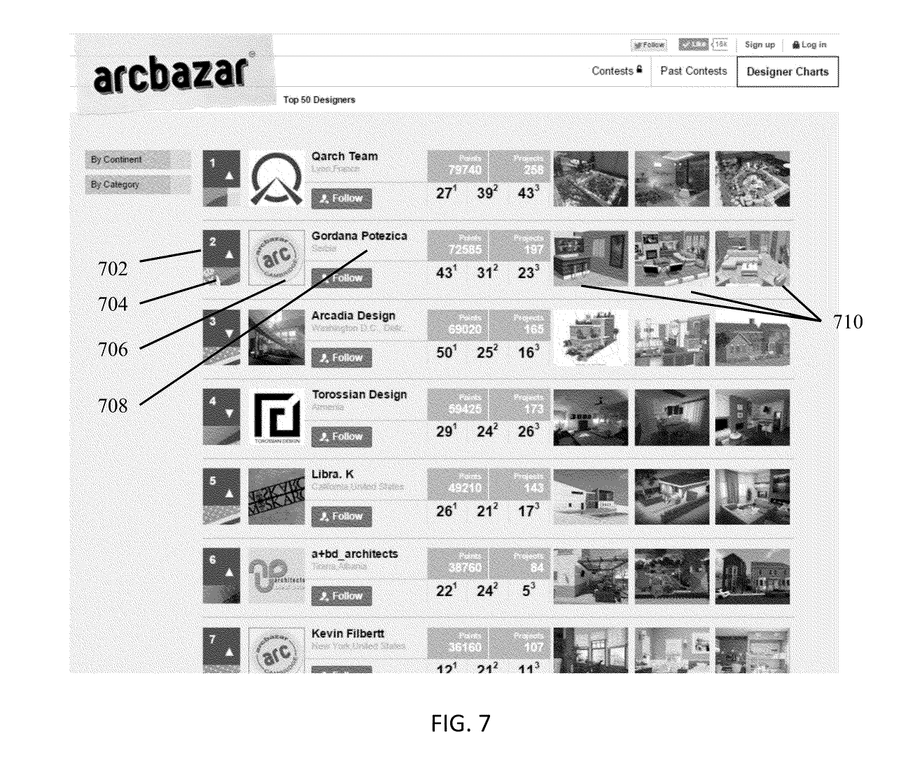

FIGS. 7-13 show exemplary screens of the user interface corresponding to various elements described in FIGS. 1-6.

FIG. 7 is a screenshot of the user interface showing a Top Designer Ranking page based on the points system described in FIG. 4. This figure shows the designer charts, which shows the Top 50 designers, based on the top participation and top performance calculations. From left to right one line shows: the overall designer rank 702, designer country flag 704, designer logo 706, designer name and location 708, and a follow button—which allows users to follow a designer and receive updates about the designer, including overall points, and the number of competitions a designer participated in. For each designer, the total number of winning designs they have submitted to the system is provided. For example, Qarch Team is shown to have won 27 1st Prizes, 39 2nd Prizes, and 43 3rd Prizes. The system also aggregates 3 thumbnails 710 of the latest top projects of the designer and places them at the end of the line. The thumbnails lead to those particular project's pages. On the right there are filters, where user can filter to see the Top 50 charts based on location. For example the user can filter based on continent, country, state, city, and/or based on category, such as remodeling, interior design, landscape design, new residential and commercial/public.

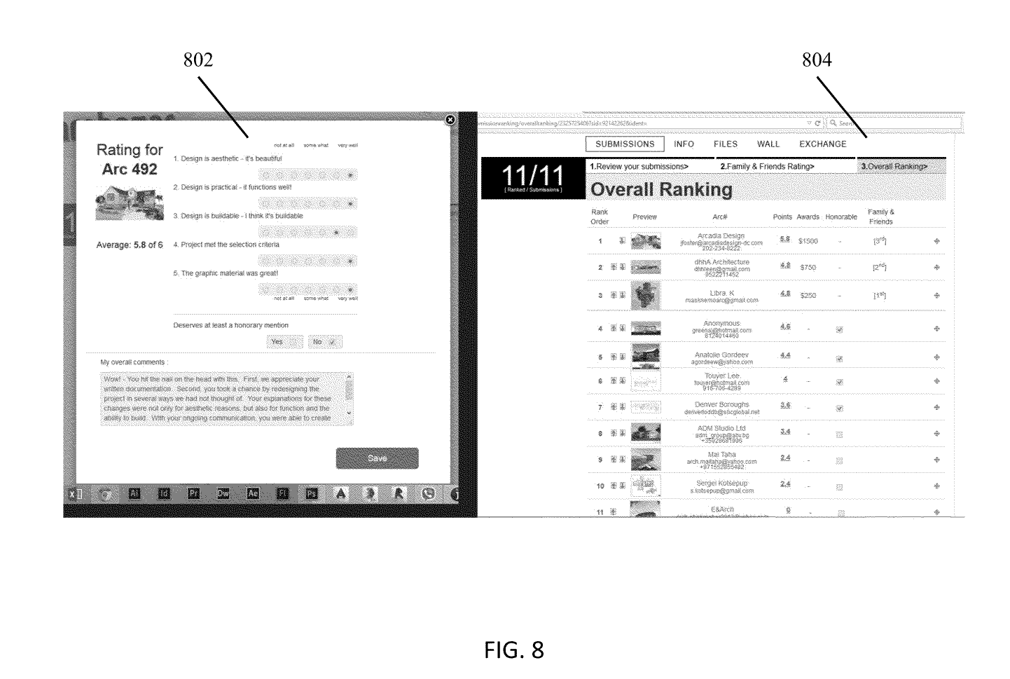

FIG. 8 is a screenshot of the rating/ranking module used to rank designs and designers as described in FIG. 4. This figure shows the rating window 802 on the left, and the overall ranking window 804 on the right. The rating window 802 allows a client to rate a project based on architectural criteria, such as beauty, functionality, structure (buildability), the heuristic evaluation criteria (e.g., the clients expectations that were stated and how did this project satisfy them), and graphic quality of a submission. These are evaluated on a 7 point (0-6) scale, ranging from “not at all” to “somewhat” to “very well”. A client can also decide whether a project should receive an honorable mention. The client can further leave a comment about this project that will go to the designer, and will be shown on the project's page. The overall ranking window 804 on the right shows all projects ranked based on the ratings the client gave. Here clients can see all design submissions in list form, the alias number, the monetary award distributed, the honorable mentions given, and the family/family evaluation results. Clients can further drag/drop the project lines up and down, finalize the ranking, and submit the ranking to the system.

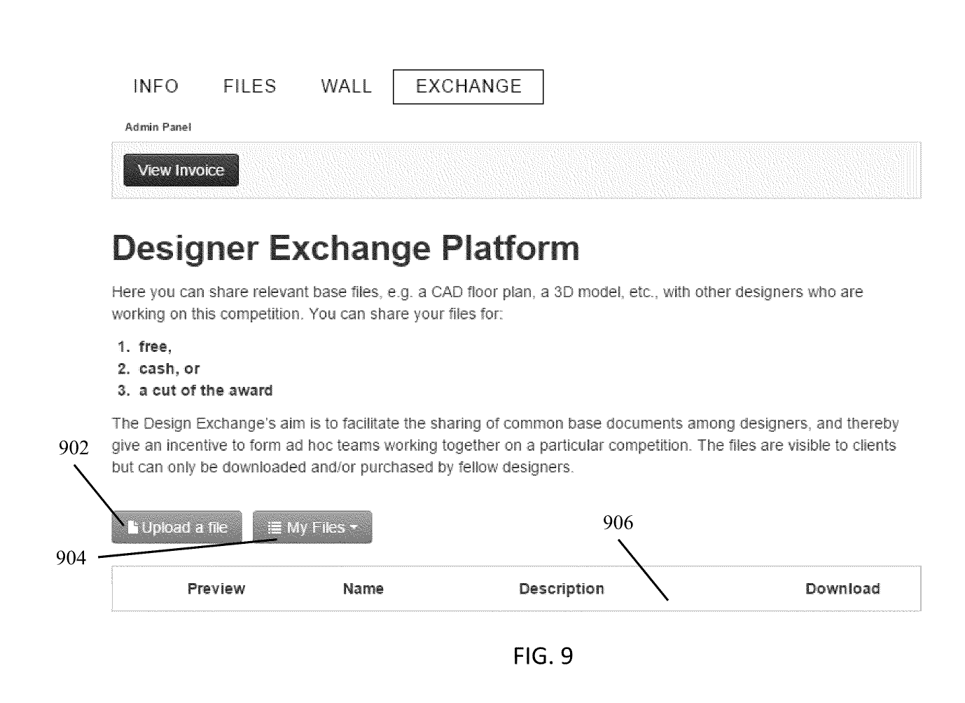

FIG. 9 is a screenshot of the designer exchange platform allowing the exchange of designs between participants as described in FIG. 4. The “Upload a File” feature 902 allows a designer to upload and share it with participating designers in this competition. After file is uploaded appears in the list 906, showing a preview thumbnail image, the name of the file, a description and a download button for other designers. The “My Files” feature 904 shows all the files a designer has uploaded to the designer exchange platform.

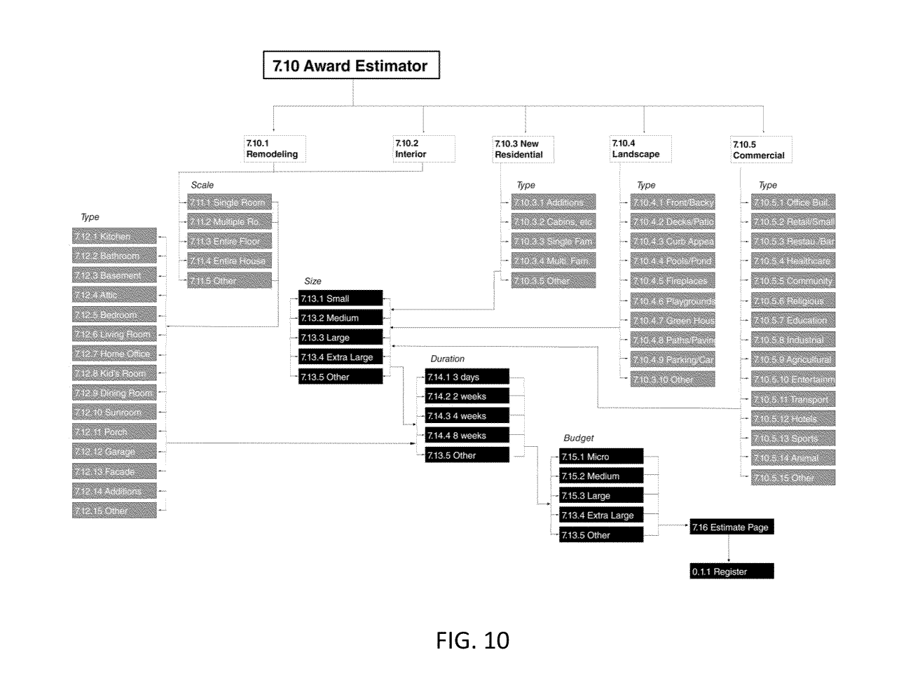

FIG. 10 is a screenshot of various schema that can be used to estimate an award as described in FIG. 6. This figure shows all the design types/items that have different multipliers to calculate the award estimation.

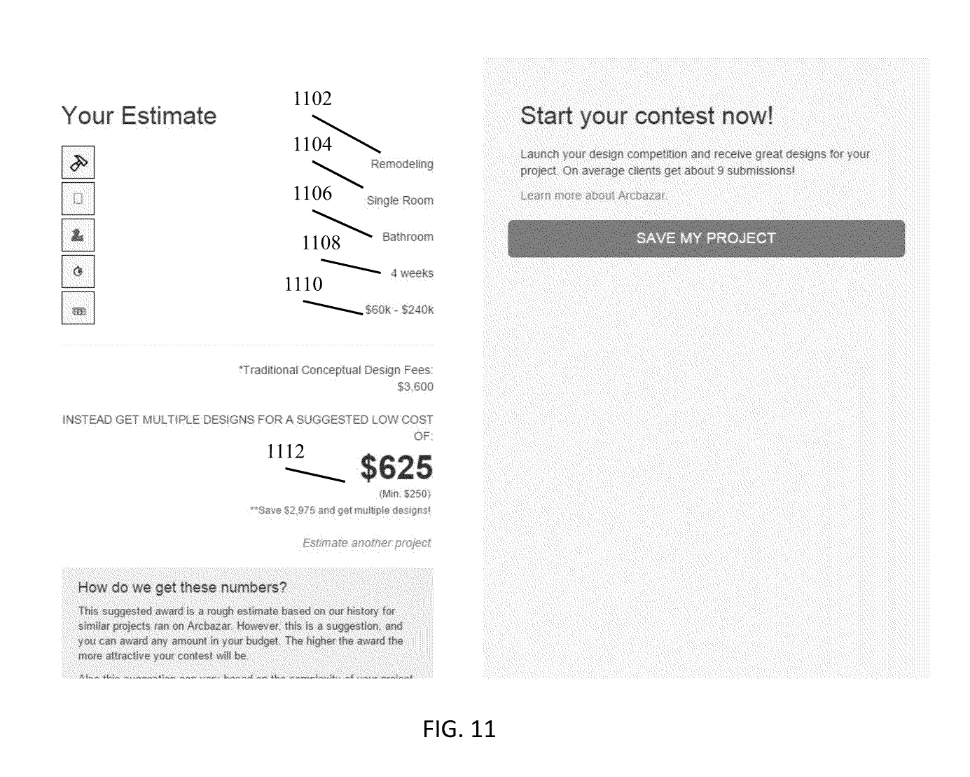

FIG. 11 is a screenshot of the award estimator user interface page for use with the award estimator described in FIG. 6. This final estimator page is the last of a series of pages, showing the award estimation of a design competition. It shows project type 1102 (e.g., remodeling), project scale 1104 (e.g., single room), project space 1106 (e.g., bathroom), project duration 1108 (e.g., 4 weeks), and project budget 1110 (e.g., $60,000). The page then shows an estimation 1112, (e.g., $625) for the cost of the design contest, and shows how much it would have been traditionally (also calculated based on an algorithm we developed). The system will also show the difference between this estimation and a traditional architect fee—the amount the client saves. The “save my project” button transfers all this information into the clients “My Competitions” page. The client can then further detail the project and launch the competition from there.

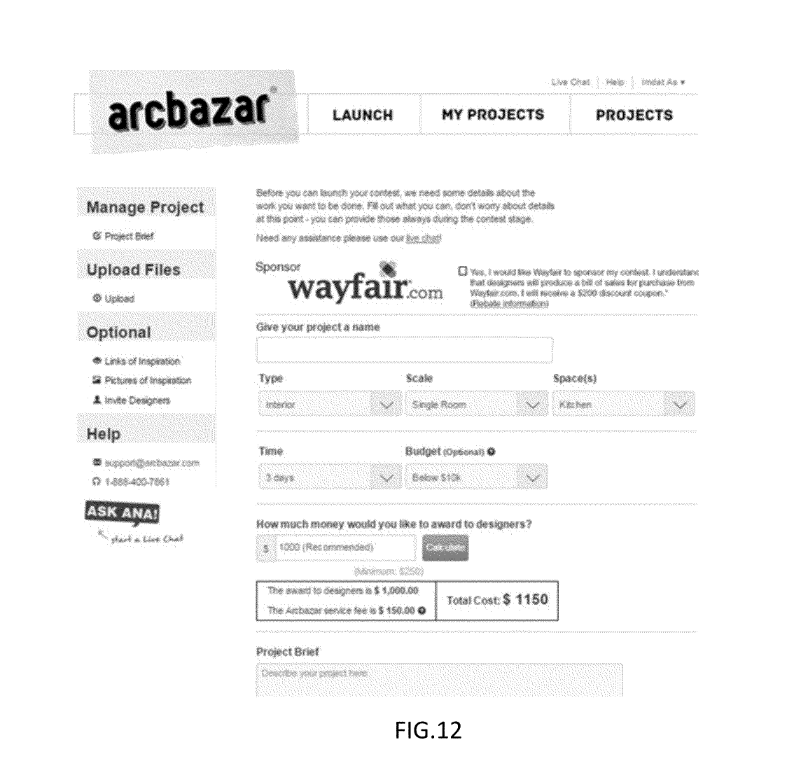

FIG. 12 is a screenshot of the upload page for a new design project associated with the process in FIG. 3. Clients can pick a sponsor,(e.g. sponsor “Wayfair”). There can be multiple sponsors. If client picks a sponsor, an amount will be deducted on the final cost amount (the sponsors pays this amount). The “Calculate” button allows a client to put in any amount for the competition award—the system then shows the service fee, the deductions from sponsors, and the final total cost amount.

FIG. 13 is a screenshot of the sponsor tagging feature of an image as described in FIG. 5. This shows a rendering/image of a design entry by a designer—at the project's image viewer. Here users can see all items, e.g., furniture, lighting fixtures, electronics, etc. that have been tagged by the designer. When user clicks on a tag such as tag 1302, a window pops up that shows more information about item, e.g. commercial, price, vendor, electronic tag (which can be used to print out and used for augmented reality apps). User can make a purchase from this page.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

1. A method for providing a design contest, comprising:
receiving from a user device a profile corresponding to a job associated with a first design competition;
publishing an indication of the design competition for bidding by designers;
receiving bids from interested designers;
ranking the received bids based on a plurality of preferences received from a user;
awarding a prize to one or more winning designers, wherein the awarding the prize comprises automatically distributing prize money to the one or more winning designers; and
sending an indication of the design contest results to the user device.
